(19) United States
(12) Patent Application Publication
(10) Pub. No.: US 2002/0158816 A1
(43) Pub. Date: Oct. 31, 2002

(54) Translating eyeglasses

(76) Inventor: Gregory S. Snider, Mt. View, CA (US)

Correspondence Address: HEWLETT-PACKARD COMPANY, Intellectual Property Administration, P.O. Box 272400, Fort Collins, CO, 80527-2400, US

(21) Appl. No.: 09/843,942

(22) Filed: Apr. 30, 2001

(51) Int. Cl. G09G 5/00

(52) U.S. Cl. 345/8

(57) ABSTRACT

A system for converting sound into visual representations, including a plurality of microphones for receiving sound, a filtering unit for directionally filtering received sound, a converting unit for converting filtered sound into display control signals, and a display unit for displaying visual representations of the filtered sound based on the display control signals.

### BACKGROUND OF THE INVENTION

1. Field of the Invention

The present invention relates generally to sound-to-text conversion devices, and more particularly to a wearable system for displaying visual representations based on directionally filtered speech.

2. Background Information

Human speech is perhaps the most common form of person-to-person communication in the world. However, for those who are deaf or hard of hearing, such communication is difficult, if not impossible, to comprehend without human or electronic assistance. Traditional methods of assistance include lip reading training and providing a human assistant to translate speech into sign language or written text. Verbal communication can also be ineffective when a listener is able to hear, but is unfamiliar with a particular language or dialect being spoken. In such an instance, a human interpreter or a bilingual dictionary may be necessary for the listener to grasp the speaker's meaning.

Various methods have been developed to address these issues using electronic technology. Hearing aids, for example, have proven effective in allowing persons with partial hearing ability to hear better. Closed and open-captioning is used in television broadcasting and motion pictures, and a system for a personal closed-captioning device is disclosed by U.S. Pat. No. 4,859,994 (Zola et al.), hereby incorporated by reference in its entirety.

U.S. Pat. No. 5,029,216 (Jhabvala et al.), hereby incorporated by reference in its entirety, discloses a visual aid in the form of a pair of eyeglasses which can indicate to a wearer the location and volume level of a sound source, but which is not used by a wearer to comprehend speech.

Accordingly, what is needed is a portable system for visually representing human speech in real-time to an individual in a noisy environment.

### SUMMARY OF THE INVENTION

The present invention is directed to a wearable system for displaying visual representations based on directionally filtered sound.

According to an exemplary embodiment of the present invention, a system for converting sound into visual representations is provided, comprising a plurality of microphones for receiving sound, a filtering unit for directionally filtering received sound, a converting unit for converting filtered sound into display control signals, and a display unit for displaying visual representations of the filtered sound based on the display control signals.

### BRIEF DESCRIPTION OF THE DRAWINGS

Other objects and advantages of the present invention will become more apparent from the following detailed description of preferred embodiments, when read in conjunction with the accompanying drawings wherein like elements have been represented by like reference numerals and wherein:

FIG. 1 illustrates a translating eyeglass assembly in accordance with an exemplary embodiment of the present invention.

### DETAILED DESCRIPTION OF THE INVENTION

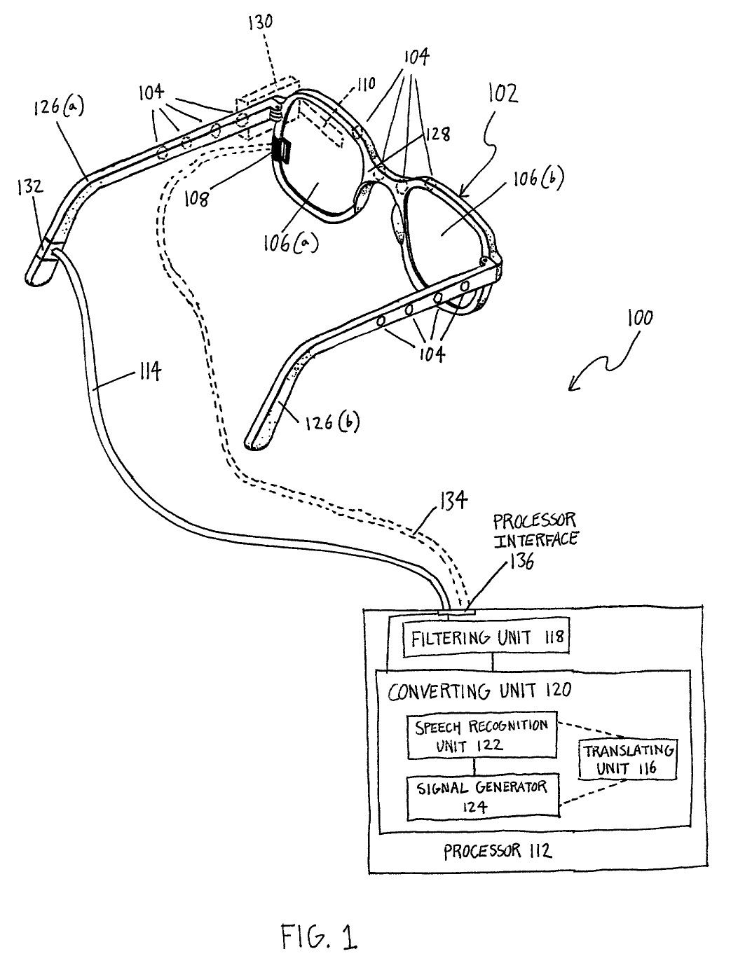

A system for converting sound into visual representations is represented in FIG. 1 as assembly 100. Assembly 100 includes a frame configured for attachment to a human head, represented as frame 102. Frame 102 is shown as a conventional eyeglass frame, but can alternatively be of another shape for attachment to a user's head, such as a hat or a visor. Frame 102 can also be made of hard plastic, metal, or any other type of formable material.

Assembly 100 includes a means for receiving sound, represented by a plurality of microphones 104. Microphones 104 are mounted on frame 102 with their receiving portions facing outward with respect to a user's head, and can be omni-directional. FIG. 1 illustrates four microphones 104 integrated to arm 126(a), four microphones 104 integrated to arm 126(b), and four microphones 104 integrated to front portion 104. The number of microphones 104 integrated to each portion of frame 102 can, however, be greater or lesser than four, of course. Also, microphones 104 can be of such a small size relative to frame 102 that they can be integrated to arms 126(a) and 126(b), and to front portion 128, without being aesthetically intrusive to assembly 100. Also, microphones 104 can be attached externally to, instead of integrated to, portions of frame 102.

Assembly 100 includes a processor 112 that can be located remotely from or attached to frame 102. When configured as a remote unit from frame 102, processor 112 can be of a size and weight small enough to, for example, conveniently attach to a user's belt or fit in a user's pocket. For example, the size and shape of processor 112 can resemble a personal paging device as known in the art. When alternatively attached to frame 102, processor 112 can be of a size and weight small enough to not interfere with the movement and comfort of a user wearing frame 102.

Processor 112 includes means for directionally filtering the received sound, represented as filtering unit 118. Using a sound localization algorithm such as that disclosed in “Binaural Application of Microphone Arrays for Improved Speech Intelligibility in a Noisy Environment” by Ivo Merks, hereby incorporated by reference in its entirety, filtering unit 118 receives audio signals from all of the microphones 104, but produces a filtered sound audio signal representing only a localized sound source. For example, filtering unit 118 can be configured as circuitry and/or software for providing an audio signal representing sound originating from a forward direction relative to frame 102. In other words, when a user is wearing frame 102 and is surrounded by multiple sound sources, filtering unit 118 can filter out sounds outside of the forward, central part of the user's field of view (i.e., background noise) and produce an audio signal representing only sounds that originate from sources located directly in front of the user's face.

Processor 112 also includes means for converting filtered sound into display control signals, represented as converting unit 120, which includes a speech recognition unit 122, a translating unit 116, and a signal generator 124. Speech recognition unit 122 can be any means known in the art for extracting information from human speech and converting it into electric signals. In an exemplary embodiment of the present invention, speech recognition unit 122 is configured as circuitry for receiving audio signals representing human speech and for outputting data signals representing text, where the circuitry includes speech recognition software to convert the audio signals into the data signals. One example of speech recognition software that can be used in speech recognition unit 122 is Sphinx, developed by Carnegie Mellon University and described in “CMU Sphinx: Open Source Speech Recognition”, www.speech.cs.cmu.edu/sphinx, hereby incorporated by reference in its entirety. Another example is Automatic Speech Recognition (ASR) Toolkit, developed by the Institute for Signal and Information Processing at Mississippi State University and described in “Automatic Speech Recognition”, www.isip.msstate.edu/projects/speech/software/asr/index.html, hereby incorporated by reference in its entirety.

Translating unit 116 can be any means known in the art for converting signals of one format to signals of another format. In the exemplary embodiment, translating unit 116 can be configured as circuitry and/or software for translating text data signals of one human language into text data signals of another human language. For example, translating unit 116 can convert text data signals representing the French language into text data signals representing the English language. Examples of translating software that can be used in translating unit 116 are those commercial available from Systran Software, such as SYSTRAN Personal, described in www.systransoft.com/personal.html, hereby incorporated by reference in its entirety.

Signal generator 124 can be any means known in the art for generating control signals for the purposing of driving a displaying means based on inputted data signals. In an exemplary embodiment, signal generator 124 receives text data signals from either speech recognition unit 122 or translating unit 116 and generates display control signals based on the text data signals.

By using units 122, 116, and 124, converting unit 120 can convert filtered sound that includes speech in a first human language into display control signals associated with text symbols in a second human language. The first and second human languages can be the same language, in which case translating unit 116 is not used, or they can be different languages. Converting unit 120 can also be connected to a memory 138, which can store information indicating a user's human language preference. For example, in the event that text data signals outputted from speech recognition unit 122 are in a language other than that indicated as preferable in memory 138, translation unit 116 will be used to convert the text data signals into signals of the preferred language. If speech recognition unit 122 outputs text data signals which are of the same language as the preferred language, then translating unit 116 is bypassed and these signals are directly routed to signal generator 124. A user can change the language preference information stored in memory 138 by any manner known in the art, such as with a switch or keyboard attached to processor 112.

Assembly 100 also includes means for displaying visual representations of the filtered sound based on the display control signals, represented as display unit 108. Display unit 108 is also mounted on frame 102 and can be integrated to frame 102 or alternatively attached as a separate unit, represented as display unit 130. Display unit 108 can be any type of optical display unit known in the art and can project visual representations, such as text symbols or images, directly into lens 106(a) supported by frame 102. Accordingly, lens 106(a) can include an integrated optical component, such as a prism, to allow visual representations to be displayed in it. Display unit 108 can, of course, be alternatively integrated to frame 102 such that it is adjacent to lens 106(b), allowing visual representations to be projected into lens 106(b).

Display unit 130 can be configured to attach to existing eyeglass frames in any manner known in the art, including with a clip-on mechanism. Display unit 130 can also be any type of optical display unit known in the art and can project visual representations onto screen 110, which is attached to display unit 130 and can be any type of display screen known in the art. Screen 110 can be positioned directly in front of lens 106(a), and can be in direct contact with lens 106(a) or can, alternatively, be positioned within a few inches away from lens 106(a). Of course, display unit 130 can alternatively be positioned on frame 102 such that it is adjacent to lens 106(b) and such that screen 110 is positioned in front of lens 106(b).

Both display units 108 and 130 can respectively project visual representations to lens 106 and screen 110 in such a way that a user wearing frame 102 views these visual representations as superimposed over his or her field of view. For example, these visual representations can be projected as translucent subtitles or captions in a user's forward line of sight without obscuring the user's sight. To a user, the visual representations can, for example, appear to be a distance of several inches away from frame 102 or can appear much further away. Display unit 108 can be adjustable by a user (for example, using a switch or button located on frame 102) to achieve a desired projection distance. An example of a commercially available device that can be used for display unit 108 and display unit 130 is a ClipOn Display by The MicroOptical Corporation, described in “MicroOptical—Product Information”, www.microoptical.com/products/index.html, hereby incorporated by reference in its entirety. Another example is the Clip-On Captioner, developed by Personal Captioning Systems, Inc and described in www.personalcaptioning.com, hereby incorporated by reference in its entirety.

Using any signal transmission method known in the art, processor 112 can receive signals from and transmit signals to the components mounted on frame 102, including microphones 104 and display unit 108. For example, a bi-directional cable 114 can be arranged between processor interface 136 and frame interface 132, which is electronically coupled to microphones 104 and to display unit 108. Both processor interface 136 and frame interface 132 can be any type of electrical interface known in the art. Also, frame interface 132 can be arranged at the end of arm 126(a) or any other location on frame 102. Microphones 104 can be coupled to interface 132 through transmission means (e.g., wires) arranged within frame 102. For example, the microphones 104 integrated to arm 126(b) can be coupled to interface 132 by wires that extend from arm 126(b), through front portion 128, and into arm 126(a).

Alternatively, cable 114 can include two unidirectional wires. For example, one unidirectional wire can be used to transmit audio signals from interface 132 to processor interface 136, and the other uni-directional wire can be used to transmit display control signals from processor interface 136 to interface 132. In another embodiment, a separate, uni-directional wire 134 can connect display unit 108 directly to processor interface 136. Wireless communication methods as known in the art can also be employed to facilitate signal transmission between processor interface 136 and interface 132.

During operation of assembly 100, a user attaches frame 102 to his or her head as is known in the art, and microphones 104 receive sound from multiple directions from a variety of sources. The received sound is converted into audio signals by microphones 104, and these audio signals are transmitted through interface 132 to processor interface 136 in one of the methods described above. Connected to processor interface 136 is filtering unit 118, to which the audio signals are then routed. Based on such predetermined microphone information as sensitivity and positioning, for example, filtering unit 118 can filter out sounds originating from sources located outside of the forward and central part of the user's field of view. For instance, if a user wearing frame 102 is facing one sound source (such as a speaking person) and is surrounded by other sound sources (such as other speaking people), filtering unit 118 receives audio signals representing all of the different received sounds, but can filter out all sounds except sounds originating from the sound source that the user is facing. Filtering unit 118 can alternatively localize sound in a direction other than a forward direction relative to frame 102.

Sound filtered by filtering unit 118 is then transmitted as an audio signal to converting unit 120, where speech recognition unit 122 operates to extract speech information, if any, from the filtered sound. Speech information is then converted by converting unit 120 to text data signals of a first human language. If information stored in memory 138 indicates the first human language as the preferred language, then the text data signals are directly routed to signal generator. However, the first human language is not indicated as the preferred language, then the text data signals are routed to translating unit 116, where the text data signals are converted to signals of a second human language. These converted signals are then routed to signal generator 124.

Signal generator 124 generates display control signals for driving display unit 108 based on inputted text data signals, received from either speech recognition unit 122 or translating unit 116. The display control signals are then routed through processor interface 136 and transmitted to interface 132 or directly to display unit 108 by one of the methods discussed above. Display unit 108 then projects visual representations into lens 106(a) based upon the received display control signals. For example, display control signals produced by signal generator 124 can be associated with text symbols in the French language, and display unit 108 will, in response to these signals, project French text into lens 106(a).

The embodiments of the present invention can benefit any individual who desires real-time conversion or translation of human speech in an environment with multiple, unrelated sound sources (i.e., a noisy environment). By directionally filtering received sound, converting filtered sound into a preferred human language format, and displaying associated visual representations on a wearable frame, an exemplary embodiment of the present invention provides a simple and convenient method for understanding a speaker of any language.

It will be appreciated by those skilled in the art that the present invention can be embodied in other specific forms without departing from the spirit or essential characteristics thereof. The presently disclosed embodiments are therefore considered in all respects illustrative and not restricted. The scope of the invention is indicated by the appended claims rather than the foregoing description and all changes that come within the meaning and range and equivalence thereof are intended to be embraced within.

What is claimed is:

1. A system for converting sound into visual representations, comprising:
a plurality of microphones for receiving sound;
a filtering unit for directionally filtering received sound;
a converting unit for converting filtered sound into display control signals; and
a display unit for displaying visual representations of the filtered sound based on the display control signals.

2. The system of claim 1, wherein at least one of the plurality of microphones and the display unit is mounted on a frame configured for attachment to a human head.

3. The system of claim 2, wherein the plurality of microphones and the display unit are both mounted on the frame.

4. The system of claim 2, wherein the frame is an eyeglass frame.

5. The system of claim 2, wherein the filtered sound is an audio signal representing sound originating from a forward direction relative to the frame.

6. The system of claim 1, wherein the microphones are omni-directional microphones.

7. The system of claim 1, wherein the visual representations are text symbols.

8. The system of claim 1, wherein the filtered sound includes speech in a first human language, and wherein the converting unit converts the filtered sound into display control signals associated with text symbols in a second human language.

9. The system of claim 8, wherein the first and second human languages are different.

10. The system of claim 2, wherein the display unit displays the visual representations to a user such that the visual representations appear in the user's forward line of sight when the user is wearing the frame.

11. The system of claim 2, wherein the display unit is integrated to the frame and projects visual representations directly into a lens supported by the frame.

12. The system of claim 2, wherein the display unit projects visual representations onto a screen arranged directly in front of a lens supported by the frame.

13. A method for converting sound to visual representations, comprising the steps of:
receiving sound;
directionally filtering the received sound;
converting the filtered sound into display control signals;
displaying visual representations of the filtered sound based on the display control signals.

14. The method of claim 13, wherein the sound is received and the visual representations are displayed on a frame configured for attachment to a human head.

15. A system for converting sound to visual representations, comprising:
means for receiving sound;
means for directionally filtering the received sound;
means for converting the filtered sound into display control signals;
means for displaying visual representations of the filtered sound based on the display control signals.

16. The system of claim 15, wherein at least one of the receiving means and the displaying means is mounted on a frame configured for attachment to a human head.

17. The system of claim 16, wherein the receiving means and the displaying means are both mounted on the frame.
